(19) United States
(12) Patent Application Publication
(10) Pub. No.: US 2026/0012861 A1
(43) Pub. Date: Jan. 8, 2026

(54) METHODS AND APPARATUSES FOR RELAY LINK CHANGE AND PATH SWITCHING TO RELAY UE

(71) Applicant: LENOVO (BEIJING) LIMITED, Beijing (CN)

(72) Inventors: Lianhai WU, Beijing (CN); Yibin ZHUO, Beijing (CN); Mingzeng DAI, Beijing (CN); Ran YUE, Beijing (CN); Haiming WANG, Beijing (CN)

(21) Appl. No.: 19/112,022

(22) PCT Filed: Nov. 15, 2022
(86) PCT No.: PCT/CN2022/132093

§ 371 Date: Mar. 14, 2025

(51) Int. Cl. H04W 36/00; H04W 76/27; H04W 88/04

(52) U.S. Cl. CPC H04W 36/03; H04W 76/27; H04W 88/04

(57) ABSTRACT

Embodiments of the present application relate to methods and apparatuses for a relay link change and path switching to a relay UE. According to an embodiment of the present application, a user equipment (UE) includes a transceiver and a processor coupled to the transceiver; and the processor is configured to: receive a radio resource control (RRC) reconfiguration message from a network node, wherein the RRC reconfiguration message includes one of: a relay link change indication if the UE accesses the network node over both a direct path between the UE and the network node and a first indirect path between the UE and the network node associated with a source relay UE; and a path switching indication to a candidate relay UE if the UE accesses the network node over the direct path, the first indirect path, or both the direct path and the first indirect path; and perform relay link change or path switching based on the RRC reconfiguration message. According to another embodiment of the present application, a source network node includes a transceiver; and a processor coupled to the transceiver; and the processor is configured to: transmit a handover request for a path switching operation to one or more candidate network nodes, wherein the handover request includes ID information of a requested target UE served by a target network node; receive a response message from the one or more candidate network nodes, wherein the response message includes ID information of at least one candidate relay UE; and transmit an RRC reconfiguration message associated with the at least one candidate relay UE to a remote UE.

### TECHNICAL FIELD

Embodiments of the present application generally relate to wireless communication technology, especially to methods and apparatuses for relay link change and path switching to a relay UE.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G wireless system or the like, details regarding how to design solutions regarding relay link change and path switching to a relay UE have not been specifically discussed yet.

### SUMMARY

Some embodiments of the present disclosure provide a user equipment (UE). The UE may include: a transceiver; and a processor coupled to the transceiver. The processor may be configured to: receive a radio resource control (RRC) reconfiguration message from a network node, wherein the RRC reconfiguration message includes one of: a relay link change indication if the UE accesses the network node over both a direct path between the UE and the network node and a first indirect path between the UE and the network node associated with a source relay UE; and a path switching indication to a candidate relay UE if the UE accesses the network node over the direct path, the first indirect path, or both the direct path and the first indirect path; and perform relay link change or path switching based on the RRC reconfiguration message.

In some embodiments of the present disclosure, if the RRC reconfiguration message includes the relay link change indication, the processor of the UE is configured to perform at least one of the following: starting a timer for relay link change upon receiving the RRC reconfiguration message; receiving a first notification message or a first PC5 unicast link release message from the source relay UE during path switching from the first indirect path to a second indirect path between the UE and the network node associated with a target relay UE; or receiving a second notification message or a second PC5 unicast link release message from the target relay UE during path switching from the first indirect path to the second indirect path.

In some embodiments of the present disclosure, the RRC reconfiguration message includes configuration information related to at least one candidate relay UE.

In some embodiments of the present disclosure, the first notification message or the second notification message indicates at least one of the following: a Uu radio link failure (RLF); a relay UE cell reselection; a relay UE handover; a Uu RRC connection failure; reception of an RRC connection rejection message; an expiry of a timer for RRC setup request; or a Uu RRC resume failure.

In some embodiments of the present disclosure, in response to receiving the first notification message or the first PC5 unicast link release message during path switching from the first indirect path to the second indirect path, the processor of the UE is configured to perform at least one of the following: ignoring the first notification message or the first PC5 unicast link release message, if the UE has not released a PC5 link between the UE and the source relay UE yet; stopping receiving data from the source relay UE; or stopping receiving the data from the source relay UE and releasing the PC5 link between the UE and the source relay UE.

In some embodiments of the present disclosure, the processor of the UE is configured to transmit a first message associated with a relay link change failure to the network node in response to at least one of the following: an expiry of the timer for relay link change; or receiving the second notification message or the second PC5 unicast link release message.

In some embodiments of the present disclosure, the first message includes at least one of the following: the expiry of the timer for relay link change; reception of the second notification message or the second PC5 unicast link release message from the target relay UE; or a set of measurement results associated with at least one candidate relay UE.

In some embodiments of the present disclosure, the processor of the UE is configured to: keep the first indirect path until the UE receives an indication to release source relay link; and perform a fallback operation to communicate with the network node over the first indirect path, if the UE fails to access the target relay UE.

In some embodiments of the present disclosure, the processor of the UE is configured to transmit information related to the fallback operation to the network node.

In some embodiments of the present disclosure, if the RRC reconfiguration message includes the path switching indication, the RRC reconfiguration message further includes one or more sets of conditions associated with one or more candidate relay UEs.

In some embodiments of the present disclosure, the processor of the UE is configured to start a timer for path switching upon at least one of the following: path switching to one candidate relay UE within the one or more candidate relay UEs; applying the RRC reconfiguration message, if the RRC reconfiguration message includes reconfigurationWithSync information element (IE) for path switching to the one candidate relay UE; or applying the RRC reconfiguration message, if the path switching indication in the RRC reconfiguration message is related to the one candidate relay UE.

Some embodiments of the present application provide a source network node (e.g., a source BS). The source network node may include: a transceiver; and a processor coupled to the transceiver. The processor may be configured to: transmit a handover request for a path switching operation to one or more candidate network nodes, wherein the handover request includes identity (ID) information of a requested target relay user equipment (UE) served by a target network node; receive a response message from the one or more candidate network nodes, wherein the response message includes ID information of at least one candidate relay UE; and transmit a radio resource control (RRC) reconfiguration message associated with the at least one candidate relay UE to a remote UE.

In some embodiments of the present disclosure, the processor of the source network node is configured to communicate with the remote UE over at least one of a direct path or an indirect path between the remote UE and the source network node associated with a source relay UE.

In some embodiments of the present disclosure, the RRC reconfiguration message includes at least one of the following: the ID information of the at least one candidate relay UE; or one or more sets of conditions associated with the at least one candidate relay UE.

In some embodiments of the present disclosure, the processor of the source network node is configured to receive a first message from a first candidate network node within the one or more candidate network nodes, and the first message indicates the source network node to cancel the path switching operation to a first candidate relay UE associated with the first candidate network node.

In some embodiments of the present disclosure, the first message includes at least one of the following: ID information of the first candidate relay UE; or a cause for cancelling the path switching operation to the first candidate relay UE.

In some embodiments of the present disclosure, the processor of the source network node is configured to receive a second message from a second candidate network node within the one or more candidate network nodes, and the second message indicates that the remote UE has successfully accessed to a target relay UE associated with the second candidate network node.

In some embodiments of the present disclosure, the second message includes at least one of the following: the ID information of the requested target relay UE; ID information of the target relay UE; or ID information of a target cell of the target relay UE.

In some embodiments of the present disclosure, the ID information of the target relay UE is added to the second message as: independent from the ID information of the requested target relay UE; or child-level information of the ID information of the requested target relay UE.

In some embodiments of the present disclosure, the second message includes the ID information of the requested target relay UE, and wherein the processor of the source network node is configured to consider that the remote UE has successfully accessed a candidate relay UE corresponding to the ID information of the requested target relay UE.

In some embodiments of the present disclosure, the processor of the source network node is configured to transmit a third message to other candidate network nodes within the one or more candidate network nodes.

In some embodiments of the present disclosure, the third message indicates at least one of the following: to cancel an ongoing path switching preparation operation or an already prepared path switching operation to a set of candidate relay UEs associated with the other candidate network nodes; or the remote UE has successfully accessed to the target relay UE.

In some embodiments of the present disclosure, the third message includes at least one of the following: ID information of a set of candidate cells associated with the other candidate network nodes; or ID information of a set of candidate relay UEs associated with the other candidate network nodes.

In some embodiments of the present disclosure, the ID information of the set of candidate relay UEs is added to the third message as child-level information of the ID information of a target cell.

In some embodiments of the present disclosure, the third message includes the ID information of a set of candidate cells associated with the other candidate network nodes and the other candidate network nodes consider that the source network node is cancelling only a handover associated with the set of candidate cells and one or more candidate relay UEs served by the set of candidate cells.

In some embodiments of the present disclosure, the processor of the source network node is configured to receive at least one of the following from the remote UE: a message associated with a relay link change failure during path switching from a first indirect path between the UE and the source network node associated with a source relay UE to a second indirect path between the remote UE and the source network node associated with a target relay UE; or information related to a fallback operation performed by the remote UE to communicate with the source network node over the first indirect path.

Some embodiments of the present application provide a candidate network node (e.g., a candidate BS). The candidate network node may include: a transceiver; and a processor coupled to the transceiver. The processor may be configured to: receive a handover request for a path switching operation from a source network node, wherein the handover request includes identity (ID) information of a requested target relay user equipment (UE) of a target network node, and the source network node is configured to communicate with a UE over at least one of a direct path or an indirect path between the UE and the source network node associated with a source relay UE; and transmit a response message to the source network node, wherein the response message includes ID information of a candidate relay UE associated with the candidate network node.

In some embodiments of the present disclosure, the processor of the candidate network node is configured to transmit a first message to the source network node, and the first message indicates the source network node to cancel the path switching operation to the candidate relay UE.

In some embodiments of the present disclosure, the first message includes at least one of the following: ID information of the candidate relay UE; or a cause for cancelling the path switching operation to the candidate relay UE.

In some embodiments of the present disclosure, the processor of the candidate network node is configured to transmit a second message to the source network node, the second message indicates that the UE has successfully accessed to the candidate relay UE, and the candidate relay UE acts as a target relay UE.

In some embodiments of the present disclosure, the second message includes at least one of the following: the ID information of the requested target relay UE; ID information of the target relay UE; or ID information of a target cell of the target relay UE.

In some embodiments of the present disclosure, at least one of the ID information of the target relay UE or the ID information of the target cell is added to the second message as: independent from the ID information of the requested target relay UE; or child-level information of the ID information of the requested target relay UE.

In some embodiments of the present disclosure, the second message includes the ID information of the requested target relay UE, and the source network node considers that the UE has successfully accessed the candidate relay UE corresponding to the ID information of the requested target relay UE.

In some embodiments of the present disclosure, the processor of the candidate network node is configured to receive a third message from the source network node, and the third message indicates at least one of the following: to cancel an ongoing path switching preparation operation or an already prepared path switching operation to a set of candidate relay UEs including the candidate relay UE; or the UE has successfully accessed to a target relay UE.

In some embodiments of the present disclosure, the third message includes at least one of the following: ID information of a set of candidate cells associated with the set of candidate network nodes including the candidate network node; or ID information of the set of candidate relay UEs including the candidate network node.

In some embodiments of the present disclosure, the ID information of the set of candidate relay UEs is added to the third message as child-level information of the ID information of the target cell.

In some embodiments of the present disclosure, the third message includes the ID information of a set of candidate cells associated with a set of candidate network nodes including the candidate network node, and the candidate network node is configured to consider that the source network node is cancelling only a handover associated with the set of candidate cells and one or more candidate relay UEs served by the set of candidate cells.

Some embodiments of the present disclosure provide a method performed by a user equipment (UE). The method may include: receiving a radio resource control (RRC) reconfiguration message from a network node, wherein the RRC reconfiguration message includes one of: a relay link change indication if the UE accesses the network node over both a direct path between the UE and the network node and a first indirect path between the UE and the network node associated with a source relay UE; and a path switching indication to a candidate relay UE if the UE accesses the network node over the direct path, the first indirect path, or both the direct path and the first indirect path; and performing relay link change or path switching based on the RRC reconfiguration message.

Some embodiments of the present disclosure provide a method performed by a source network node (e.g., a source BS). The method may include: transmitting a handover request for a path switching operation to one or more candidate network nodes, wherein the handover request includes identity (ID) information of a requested target relay user equipment (UE) served by a target network node; receiving a response message from the one or more candidate network nodes, wherein the response message includes ID information of at least one candidate relay UE; and transmitting a radio resource control (RRC) reconfiguration message associated with the at least one candidate relay UE to a remote UE.

Some embodiments of the present disclosure provide a method performed by a candidate network node (e.g., a candidate BS). The method may include: receiving a handover request for a path switching operation from a source network node, wherein the handover request includes identity (ID) information of a requested target relay user equipment (UE) of a target network node, and the source network node is configured to communicate with a UE over at least one of a direct path or an indirect path between the UE and the source network node associated with a source relay UE; and transmitting a response message to the source network node, wherein the response message includes ID information of a candidate relay UE associated with the candidate network node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE, a source network node (e.g., a source BS), or a candidate network node (e.g., a candidate BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary wireless communication system in accordance with some embodiments of the present application.

FIG. 3 illustrates a flow chart of a method of performing relay link change or path switching in accordance with some embodiments of the present application.

FIG. 4 illustrates a flow chart of a method of transmitting a handover request in accordance with some embodiments of the present application.

FIG. 5 illustrates a flow chart of a method of receiving a handover request in accordance with some embodiments of the present application.

FIG. 6 illustrates a flow chart of a relay link change operation in accordance with some embodiments of the present application.

FIG. 7 illustrates a flow chart of a relay link change operation in accordance with some embodiments of the present application.

FIG. 8 illustrates a flow chart of a path switching operation to a relay UE in accordance with some embodiments of the present application.

FIG. 9 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As illustrated and shown in FIG. 1, a wireless communication system 100 includes at least two UEs (i.e., UE 101 and relay UE 102) and at least one BS (e.g., BS 103) for illustrative purpose. Although a specific number of UE(s) and BS(s) are depicted in FIG. 1, it is contemplated that any number of UE(s) and BS(s) may be included in the wireless communication system 100. As shown in FIG. 1. UE 101 may communicate with BS 103 via a direct path between UE 101 and BS 103 or via an indirect path between the UE 101 and BS 103 through relay UE 102. That is, UE 101 may communicate with BS 103 via multiple paths. The multiple paths may also be named as “multi-path” or the like.

UE(s) in the wireless communication system 100 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IOT) devices, or the like. According to some embodiments of the present application, UE(s) may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, UE(s) includes wearable devices, such as smart watches, fitness bands, optical head-mounted displays, or the like. Moreover, UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) may communicate directly with BS(s) via UL communication signals.

In some embodiments of the present application, each of UE(s) may be deployed an IoT application, an enhanced mobile broadband (eMBB) application and/or an ultra-reliable and low latency communication (URLLC) application. It is contemplated that the specific type of application(s) deployed in UE(s) may be varied and not limited.

BS(s) in the wireless communication system 100 may be distributed over a geographic region. In certain embodiments of the present application, each of BS(s) may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) is generally a part of a radio access network that may include one or more controllers communicably coupled to one or more corresponding BS(s). Each of BS(s) may include one or more cells. Each UE(s) may perform a cell section procedure between different cell(s) of different BS(s).

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G new radio (NR) of the 3GPP protocol, wherein BS(s) transmit data using an OFDM modulation scheme on the DL and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) in the wireless communication system 100 may communicate using other communication protocols, such as the IEEE 802.11 family of wireless communication protocols. Further, in some embodiments of the present application, BS(s) may communicate over licensed spectrums, whereas in other embodiments, BS(s) may communicate over unlicensed spectrums. The present application is not intended to be limited to the implementation of any particular wireless communication system architecture or protocol. In yet some embodiments of present application, BS(s) may communicate with UE(s) using the 3GPP 5G protocols.

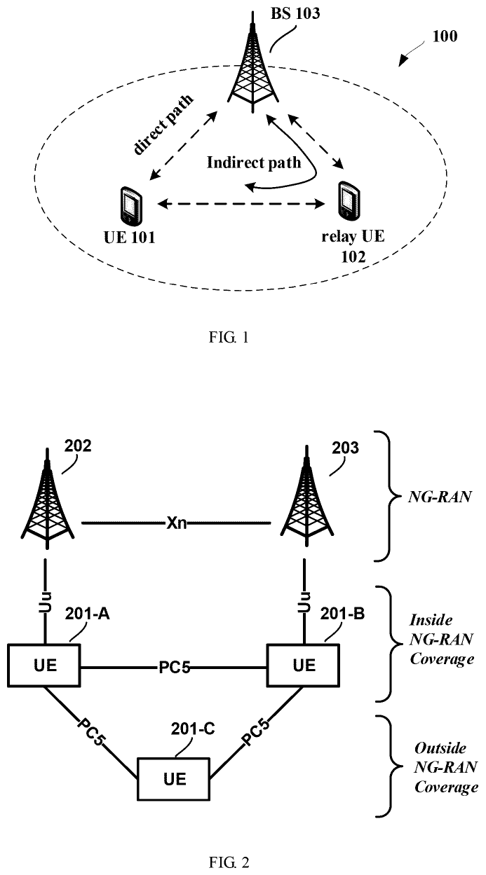

FIG. 2 illustrates an exemplary wireless communication system in accordance with some embodiments of the present application. As shown in FIG. 2, the wireless communication system includes one gNB 202, one ng-eNB 203, and some V2X UEs, i.e., UE 201-A, UE 201-B, and UE 201-C. Each of these UEs may refer to UE 101a, UE 101b, or relay UE 103 as shown and illustrated in FIG. 1.

In particular, UE 201-A is within the coverage of gNB 202, UE 201-B is within the coverage of ng-eNB 203, and UE 201-C is out of coverage of gNB 202 and ng-eNB 203. Support of V2X services via the PC5 interface can be provided by NR sidelink communication and/or V2X sidelink communication. NR sidelink communication can support one of three types of transmission modes for a pair of a Source Layer-2 (L2) identity (ID) and a Destination L2 ID: unicast transmission; groupcast transmission; and broadcast transmission. Sidelink transmission and reception over the PC5 interface are supported when the UE is either inside of the NG-RAN coverage or outside of the NG-RAN coverage.

UE 201-A, which is within the coverage of gNB 202, may perform sidelink unicast transmission, sidelink groupcast transmission, or sidelink broadcast transmission over the PC5 interface. UE 201-C, which is out of coverage, can also perform sidelink transmission and reception over the PC5 interface. It is contemplated that, in accordance with some other embodiments of the present application, a V2X communication system may include more or fewer BSs, and more or fewer V2X UEs. Moreover, it is contemplated that names of V2X UEs (which represent a Tx UE, an Rx UE, and etc.) as illustrated and shown in FIG. 2 may be different, e.g., UE 201c, UE 204f, and UE 208g or the like.

In addition, although each V2X UE as shown in FIG. 2 is illustrated in the shape of a cell phone, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 2, UE 201-A functions as a Tx UE, and UE 201-B and UE 201-C function as an Rx UE. UE 201-A may exchange V2X messages with UE 201-B, or UE 201-C through a sidelink, for example, PC5 interface as defined in 3GPP TS 23.303. UE 201-A may transmit information or data to other UE(s) within the V2X communication system, through sidelink unicast, sidelink groupcast, or sidelink broadcast. The sidelink communication includes NR sidelink communication, and V2X sidelink communication. For instance, UE 201-A may transmit data to UE 201-C in a NR sidelink unicast session, and UE 201-B may transmit data to UE 201-C in a V2X sidelink unicast session. UE 201-A may transmit data to UE 201-B and UE 201-C in a groupcast group by a sidelink groupcast transmission session.

Sidelink communication includes NR Sidelink communication and V2X Sidelink communication. FIG. 2 demonstrates the NR Sidelink communication specified in 3GPP TS 38.311. V2X sidelink communication is specified in 3GPP TS 36.311.

Currently, details regarding how to design relay link change and path switching to a relay UE have not been specifically discussed yet. Embodiments of the present application aim to solve such issues. In the embodiments of the present application, a multi-path case refers to a direct path between a UE and a BS and/or an indirect path between the UE and the BS via a relay UE. The multi-path may also be named as “multiple paths” or the like.

In particular, in some embodiments, in a multi-path case, a mechanism of handling the case that a remote UE receives a notification message or a PC5 unicast link release message from a source relay link in a relay link change scenario is studied. In some embodiments, a fallback mechanism for a source relay UE is studied if a timer for relay link change expires. In some embodiments, a report from a UE to a source direct path is needed after the successful fallback operation of the UE. In some embodiments, during conditional path switching to a target relay UE case, a condition to stop a timer for path switching to the target relay UE is introduced. In some embodiments, information (e.g., a cause and/or relay UE ID) is needed for some Xn messages for path switching to a target relay UE. More details will be illustrated in the following text in combination with the appended drawings.

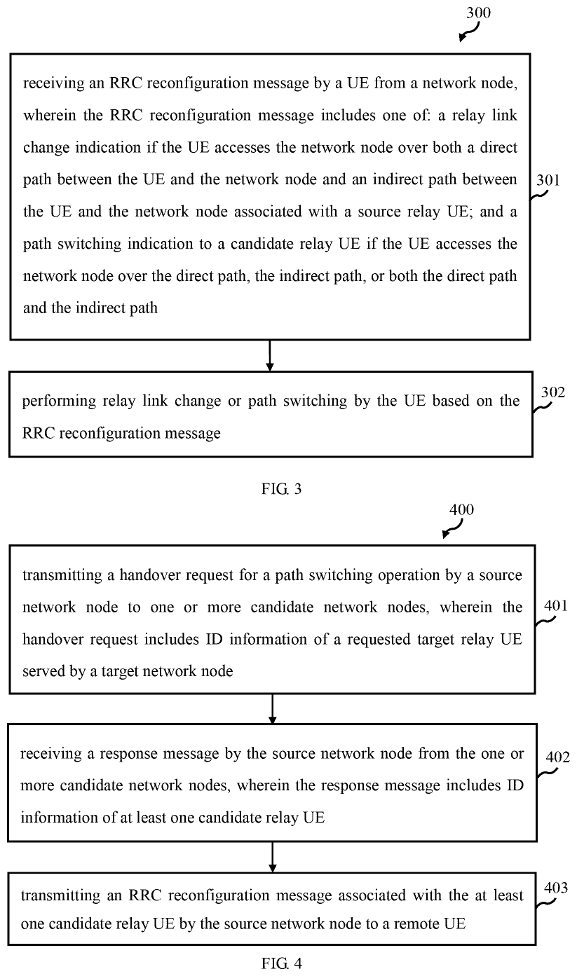

FIG. 3 illustrates a flow chart of a method of performing relay link change or path switching in accordance with some embodiments of the present application. The method may be performed by a UE or a remote UE (e.g., UE 101, UE 201-C, UE 601, UE 701, or UE 801 as illustrated and shown in any of FIGS. 1, 2, and 6-8). Although described with respect to a UE or a remote UE, it should be understood that other devices may be configured to perform a method similar to that of FIG. 3.

In the exemplary method 300 as shown in FIG. 3, in operation 301, a UE (e.g., UE 101 illustrated and shown in FIG. 1) may receive an RRC reconfiguration message from a network node (e.g., BS 103 illustrated and shown in FIG. 1). The RRC reconfiguration message may include one of:
(1) A relay link change indication, if the UE accesses the network node over both “a direct path between the UE and the network node” and “an indirect path between the UE and the network node associated with a source relay UE (e.g., relay BS 102 illustrated and shown in FIG. 1)”. This indirect path is denoted as “indirect path #1” for simplicity.
(2) A path switching indication to a candidate relay UE, if the UE accesses the network node over the direct path, indirect path #1, or both the direct path and indirect path #1.

In operation 302, the UE may perform relay link change or path switching based on the RRC reconfiguration message.

In some embodiments, if the RRC reconfiguration message includes the relay link change indication, the UE may perform at least one of the following:
(1) Starting a timer for relay link change upon receiving the RRC reconfiguration message.
(2) Receiving a notification message (denoted as “notification message #1”) or a PC5 unicast link release message (denoted as “PC5 unicast link release message #1”) from the source relay UE during path switching from indirect path #1 to an indirect path (denoted as “indirect path #2”) between the UE and the network node associated with a target relay UE (e.g., a relay UE not shown in FIG. 1). In some embodiments, notification message #1 indicates at least one of the following: a Uu RLF between the source relay UE and the network node; a cell reselection of the source relay UE; a handover of the source relay UE; a Uu RRC connection failure of the source relay UE; an RRC connection rejection message received by the source relay UE; an expiry of a timer for RRC setup request (e.g., timer T300 as specified in 3GPP standard document) at the source relay UE; or a Uu RRC resume failure of the source relay UE.
(3) Receiving a notification message (denoted as “notification message #2”) or a PC5 unicast link release message (denoted as “PC5 unicast link release message #2”) from the target relay UE during path switching from indirect path #1 to indirect path #2. In some embodiments, notification message #2 indicates at least one of the following: a Uu RLF between the target relay UE and the network node; a cell reselection of the target relay UE; a handover of the target relay UE; a Uu RRC connection failure of the target relay UE; an RRC connection rejection message received by the target relay UE; an expiry of a timer for RRC setup request (e.g., timer T300) at the target relay UE; or a Uu RRC resume failure of the target relay UE.

In some embodiments, the RRC reconfiguration message includes configuration information related to at least one candidate relay UE.

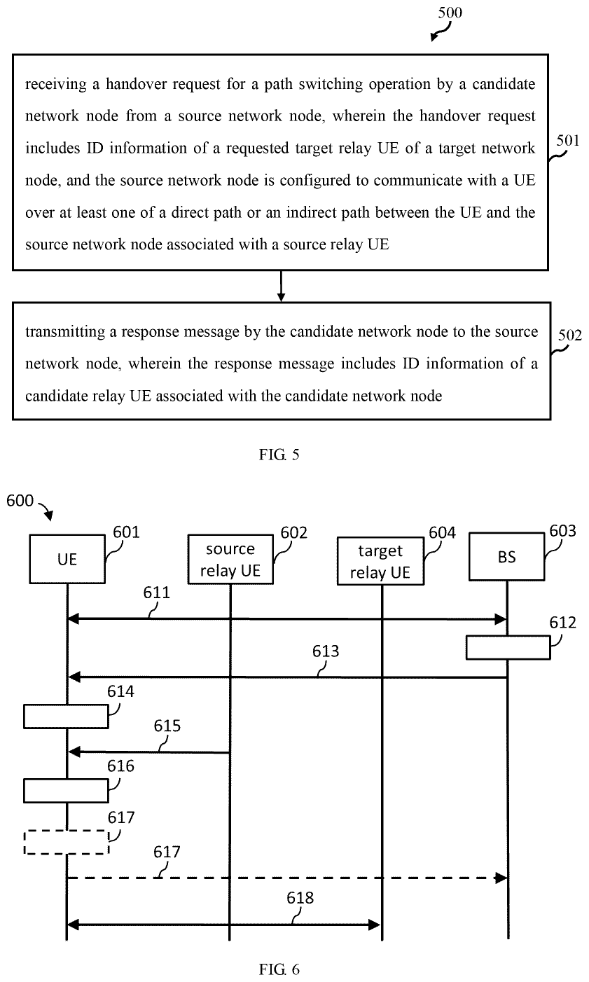

In some embodiments, in response to receiving notification message #1 or PC5 unicast link release message #1 from the source relay UE during path switching from indirect path #1 to indirect path #2, the UE may perform one of the following:
(1) ignoring notification message #1 or PC5 unicast link release message #1, if the UE has not released a PC5 link between the UE and the source relay UE yet;
(2) stopping receiving data from the source relay UE; and
(3) stopping receiving data from the source relay UE and releasing the PC5 link between the UE and the source relay UE. A specific example is described in the embodiments of FIG. 6 as follows.

In some embodiments, the UE may transmit a message associated with a relay link change failure to the network node in response to: an expiry of the timer for relay link change; and/or receiving notification message #2 or PC5 unicast link release message #2 from the target relay UE. In an embodiment, the message associated with the relay link change failure may include or indicate at least one of the following:
(1) an expiry of the timer for relay link change (e.g., timer T420 as specified in 3GPP standard document);
(2) reception of notification message #2 or PC5 unicast link release message #2; or
(3) a set of measurement results associated with at least one candidate relay UE.

In some embodiments, the UE may keep indirect path #1 until the UE receives an indication to release source relay link, and the UE may perform a fallback operation to communicate with the network node over indirect path #1, if the UE fails to access the target relay UE. For instance, upon an expiry of the timer for relay link change (e.g., timer T420), the UE may determine that it fails to access the target relay UE, and then may perform the fallback operation.

In the embodiments of the subject application, when a remote UE, which communicates with a BS via a target relay UE, performs a fallback operation, the remote UE may release a PC5 link between the remote UE and the target relay UE and communicate with the BS via an indirect PC5 link between the remote UE and the source relay UE. Namely, by performing a fallback operation, the remote UE may switch back from the target relay link to the source relay link.

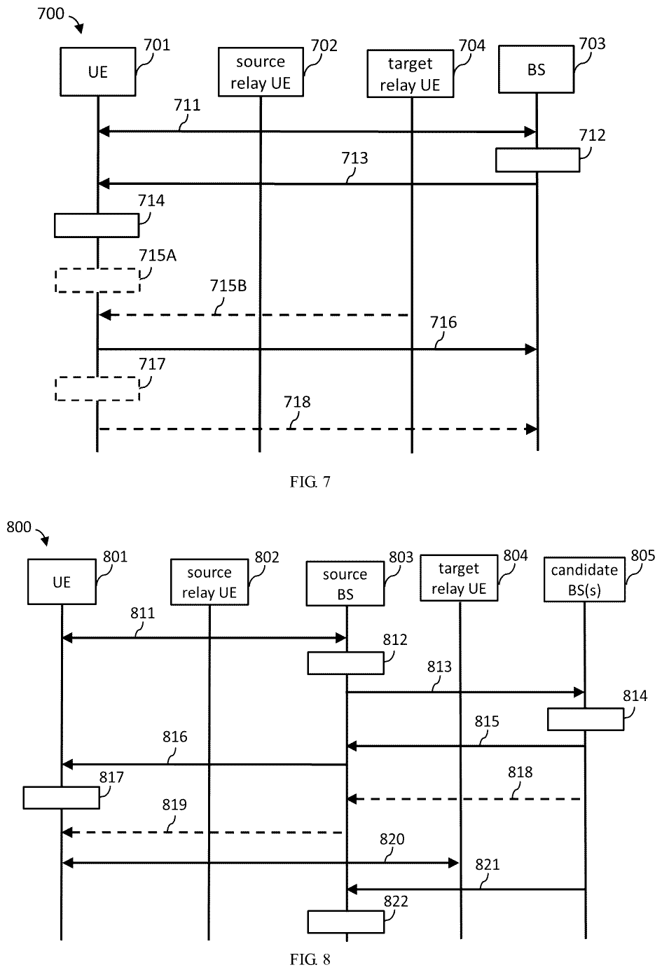

Referring back to FIG. 3, in some embodiments, after performing the fallback operation, the UE may transmit information related to the fallback operation to the network node. A specific example is described in the embodiments of FIG. 7 as follows.

In some embodiments, if the RRC reconfiguration message includes the path switching indication, the RRC reconfiguration message further includes one or more sets of conditions associated with one or more candidate relay UEs, e.g., one or more sets of path switching conditions.

In some embodiments, the UE may start a timer for path switching upon at least one of the following:
(1) path switching to one candidate relay UE within the one or more candidate relay UEs;
(2) applying the RRC reconfiguration message, if the RRC reconfiguration message includes reconfigurationWithSync IE for path switching to the one candidate relay UE; or
(3) applying the RRC reconfiguration message, if the path switching indication in the RRC reconfiguration message is related to the one candidate relay UE. For instance, during applying the RRCReconfiguration message, the UE may apply parameters included in the RRCReconfiguration message. A specific example is described in the embodiments of FIG. 8 as follows.

In an embodiment, after receiving the RRC reconfiguration message, the UE may evaluate the one or more sets of conditions. Once a set of conditions associated with a candidate relay UE is met, the UE may perform path switching to the candidate relay UE.

In some embodiments of the present application, new events which are related to trigger condition for measurement report or path switching condition(s), i.e., EventZ1 and EventZ2, are defined as below. For instance, EventZ1 and/or EventZ2 may be defined in RRC specification. The parameter, e.g., an offset will be configured to a UE who may determine whether the measurement report(s) is triggered based on the configured EventZ1 or EventZ2. EventZ1 and EventZ2 may be used for the case of indirect-to-indirect path switching.

In some cases, the UE may evaluate whether EventZ1 and/or EventZ2 are met before report measurement result(s) associated with a candidate relay UE to a BS. When EventZ1 and/or EventZ2 are met, the UE may report the measurement result(s). In some other cases, the UE may evaluate whether EventZ1 and/or EventZ2 are met before performing path switching. When EventZ1 and/or EventZ2 are met, the UE may perform path switching to a candidate relay UE.
EventZ1: (serving relay UE becomes worse than threshold1 and candidate Relay UE becomes better than threshold2)
   The UE shall consider the entering condition for this event to be satisfied when both condition Z1-1 and condition Z1-2, as specified below, are fulfilled;
   The UE shall consider the leaving condition for this event to be satisfied when condition Z 1-3 or condition Z 1-4, i.e. at least one of the two, as specified below, is fulfilled;

Inequality Z1-1 (Entering condition 1)

$$Mp + Hys < Thresh 1$$

Inequality Z1-2 (Entering condition 2)

$$Mr - Hys > Thresh 2$$

Inequality Z1-3 (Leaving condition 1)

$$Mp - Hys > Thresh 1$$

Inequality Z1-4 (Leaving condition 2)

$$Mr + Hys < Thresh 2$$

The variables in the formula are defined as follows:
Mp is the measurement result of the serving relay UE, not taking into account any offsets.
Mr is the measurement result of the candidate L2 U2N Relay UE, not taking into account any offsets.
Hys is the hysteresis parameter for this event (i.e. hysteresis as defined within reportConfigInterRAT for this event).
Thresh1 is the threshold parameter for this event (i.e. y1-Threshold1 as defined within reportConfigInterRAT for this event).
Thresh 2 is the threshold parameter for this event (i.e. y1-Threshold2-Relay as defined within reportConfigInterRAT for this event).
Mp is expressed in dBm in case of RSRP, or in dB in case of RSRQ and SINR.
Mr is expressed in dBm or dB, depending on the measurement quantity of candidate L2 U2N Relay UE.
Hys are expressed in dB.
Thresh1 is expressed in the same unit as Mp.
Thresh2 is expressed in the same unit as Mr.
Event Z2 (serving L2 U2N relay UE becomes offset better than candidate L2 U2N Relay UE)

FIG. 4 illustrates a flow chart of a method of transmitting a handover request in accordance with some embodiments of the present application. The method may be performed by a source network node (e.g., BS 103, gNB 202, or source BS 803 illustrated and shown in any of FIGS. 1, 2, and 8). Although described with respect to a source network node (e.g., a source BS), it should be understood that other devices may be configured to perform a method similar to that of FIG. 4. A specific example of the embodiments of FIG. 4 is described in the embodiments of FIG. 8 as follows.

In the exemplary method 400 as shown in FIG. 4, in operation 401, a source network node (e.g., source BS 803 illustrated and shown in FIG. 8) may transmit a handover request for a path switching operation to one or more candidate network nodes (e.g., candidate BS(s) 805 illustrated and shown in FIG. 8). The handover request may include ID information of a requested target relay UE served by a target network node, which may be a target relay UE that is selected by the source network node.

In operation 402, the source network node may receive one or more response messages from the one or more candidate network nodes. The one or more response messages may include ID information of at least one candidate relay UE. For instance, if there are three candidate network nodes (e.g., candidate gNB #1, candidate gNB #2, and candidate gNB #3 in the embodiments of FIG. 8), the source network node may receive three response messages each of which includes ID information of one candidate relay UE associated with the corresponding candidate network node.

In operation 403, the source network node may transmit an RRC reconfiguration message associated with the at least one candidate relay UE to a remote UE (e.g., UE 801 illustrated and shown in FIG. 8).

In some embodiments, the network node may communicate with the remote UE over at least one of “a direct path” or “an indirect path between the remote UE and the source network node associated with a source relay UE”, i.e., via multi-path.

In some embodiments, the RRC reconfiguration message includes at least one of: the ID information of the at least one candidate relay UE; and/or one or more sets of conditions (e.g., set(s) of path switching conditions) associated with the at least one candidate relay UE.

In some embodiments, the source network node may receive a message (denoted as “message #1”) from a candidate network node (denoted as “candidate network node #1”) within the one or more candidate network nodes. Message #1 may indicate the source network node to cancel the path switching operation to a candidate relay UE (denoted as “candidate relay UE #1”) associated with candidate network node #1. In an embodiment, message #1 may include: ID information of candidate relay UE #1; and/or a cause for cancelling the path switching operation to candidate relay UE #1. In an embodiment, message #1 may be a conditional handover cancel message, e.g., CONDITIONAL HANDOVER CANCEL message, or a conditional path switching cancel message.

In general, a target NG-RAN node initiates a procedure by sending an Xn message e.g. the CONDITIONAL HANDOVER CANCEL message to a source NG-RAN node. The target NG-RAN node shall indicate the reason for cancelling the conditional path switching by means of an appropriate cause value. At the reception of the Xn message, the source NG-RAN node shall consider that the target NG-RAN node is about to remove any reference to, and release any resources previously reserved for candidate cells associated to the UE-associated signalling identified by the Source NG-RAN node UE XnAP ID IE and the Target NG-RAN node UE XnAP ID IE. If the Candidate Cells To Be Cancelled List IE is included in Xn message, the source NG-RAN node shall consider that only the resources reserved for the cells identified by the included NG-RAN CGI are about to be released.

Referring back to FIG. 4, in some embodiments, the source network node may receive a message (denoted as “message #2”) from a candidate network node (denoted as “candidate network node #2”) within the one or more candidate network nodes. Message #2 may indicate that the UE has successfully accessed to a target relay UE (e.g., target relay UE 804 illustrated and shown in FIG. 8) associated with candidate network node #2. Candidate network node #2 may be the same as or different from candidate network node #1.

In an embodiment, message #2 may include: the ID information of the requested target relay UE; ID information of the target relay UE; and/or ID information of a target cell of the target relay UE. For instance, in some embodiments, the ID information of the target relay UE may be added to message #2 as independent from the ID information of the requested target relay UE, e.g., as shown in Table 1 as below. In some other embodiments, the ID information of the target relay UE may be added to message #2 as child-level information of the ID information of the requested target relay UE, e.g., as shown in Table 2 as below. In an embodiment, message #2 may be a handover success message, e.g., HANDOVER SUCCESS message.

In general, a target NG-RAN node may initiate a procedure by sending an Xn message e.g. the HANDOVER SUCCESS message to a source NG-RAN node. If late data forwarding was configured for this UE, the source NG-RAN node shall start data forwarding using the tunnel information related to the global target cell ID provided in the Xn message. When the source NG-RAN node receives the Xn message, it shall consider all other CHO preparations accepted for this UE under the same UE-associated signalling connection in the target NG-RAN node as cancelled.

In some embodiments of FIG. 4, the ID information of the target relay UE may be added to the Xn message e.g. the HANDOVER SUCCESS message, for example, “Target relay UE ID” as shown in Table 1 as below.

TABLE 1

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | ignore |
| Type | | | | | |
| Source | M | NG-RAN | Allocated at the | YES | reject |
| NG-RAN | | node UE | source | | |
| node UE | | XnAP ID | NG-RAN node. | | |
| XnAP ID | | 9.2.3.16 | | | |
| Target | M | NG-RAN | Allocated at the | YES | reject |
| NG-RAN | | node UE | target NG-RAN | | |
| node UE | | XnAP ID | node. | | |
| XnAP ID | | 9.2.3.16 | | | |
| Requested | M | Target | Target cell | YES | reject |
| Target | | Cell | indicated in the | | |
| Cell ID | | Global | corresponding | | |
| | | ID | Handover | | |
| | | 9.2.3.25 | Preparation | | |
| | | | procedure | | |
| Target | | | | | |
| relay UE | | | | | |
| ID | | | | | |

In some other embodiments of FIG. 4, the ID information of the target relay UE may be added to the Xn message e.g. the HANDOVER SUCCESS message as child-level information of the ID information of the requested target relay UE, for example, “Target relay UE ID” is child-level information of “Requested Target Cell ID” as shown in Table 2 as below.

TABLE 2

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | ignore |
| Type | | | | | |
| Source | M | NG-RAN | Allocated at | YES | reject |
| NG-RAN | | node UE | the source | | |
| node UE | | XnAP ID | NG-RAN | | |
| XnAP ID | | 9.2.3.16 | node. | | |
| Target | M | NG-RAN | Allocated at | YES | reject |
| NG-RAN | | node UE | the target | | |
| node UE | | XnAP ID | NG-RAN | | |
| XnAP ID | | 9.2.3.16 | node. | | |
| Requested | M | Target | Target cell | YES | reject |
| Target | | Cell | indicated in | | |
| Cell ID | | Global | the | | |
| | | ID | corresponding | | |
| | | 9.2.3.25 | Handover | | |
| | | | Preparation | | |
| | | | procedure | | |
| >>Target | | | | | |
| relay UE | | | | | |
| ID | | | | | |

Referring back to FIG. 4, in some embodiments, message #2 may include the ID information of the requested target relay UE. The source network node may consider that the UE has successfully accessed a candidate relay UE corresponding to the ID information of the requested target relay UE.

In some embodiments, the source network node may transmit a message (denoted as “message #3”) to other candidate network nodes within the one or more candidate network nodes, to indicate at least one of the following:
(1) To cancel an ongoing path switching preparation operation or an already prepared path switching operation to a set of candidate relay UEs associated with the other candidate network nodes.
(2) The UE has successfully accessed to the target relay UE.

In some embodiments, message #3 may include at least one of the following:
(1) ID information of a set of candidate cells associated with the other candidate network nodes.
(2) ID information of a set of candidate relay UEs associated with the other candidate network nodes.

In some embodiments, the ID information of the set of candidate relay UEs is added to message #3, e.g., “Candidate Relay UE(s) ID” as shown in Table 3 as below. For instance, the ID information of the set of candidate relay UEs is “Candidate Relay UE List To Be Cancelled” IE in message #3, e.g., as shown in Table 4 as below. If the “Candidate Relay UE List To Be Cancelled” IE is included in message #3, the target network node may consider that the source network node is cancelling the handover associated with the candidate relay UE. “Candidate Relay UE List To Be Cancelled” may also be named as “Candidate Relay UE To Be Cancelled List” or the like without departing from the spirit and scope of the disclosure.

In some other embodiments, the ID information of the set of candidate relay UEs is added to message #3 as child-level information of the ID information of the target cell (e.g., “Target Cell ID”), e.g., “Candidate Relay UE(s) ID” is child-level information of “Target Cell ID” as shown in Table 5, or “Candidate Relay UE List To Be Cancelled” is child-level information of “Target Cell ID” as shown in Table 6 as below.

In an embodiment, message #3 may be a handover cancel message, e.g., HANDOVER CANCEL message.

In general, a source NG-RAN node may initiate a procedure by sending an Xn message e.g. the HANDOVER CANCEL message to a target NG-RAN node. The source NG-RAN node shall indicate the reason for cancelling the handover by means of an appropriate cause value. If the “Candidate Cells To Be Cancelled List” IE is included in the Xn message, the target NG-RAN node shall consider that the source NG-RAN node is cancelling only the handover associated to the candidate cells identified by the included NG-RAN CGI and associated to the same UE-associated signaling connection identified by the Source NG-RAN node UE XnAP ID IE and, if included, also by the Target NG-RAN node UE XnAP ID IE.

In some embodiments of FIG. 4, the ID information of the set of candidate relay UEs may be added to the Xn message e.g. the HANDOVER CANCEL message, for example, “Candidate Relay UE(s) ID” as shown in Table 3 or “Candidate Relay UE List To Be Cancelled” as shown in Table 4 as below.

TABLE 3

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| Source | M | | NG-RAN | Allocated at | YES | reject |
| NG-RAN | | | node UE | the source | | |
| node UE | | | XnAP ID | NG-RAN | | |
| XnAP ID | | | 9.2.3.16 | node. | | |
| Target | M | | NG-RAN | Allocated at | YES | reject |
| NG-RAN | | | node UE | the target | | |
| node UE | | | XnAP ID | NG-RAN | | |
| XnAP ID | | | 9.2.3.16 | node. | | |
| Candidate | | 0 . . . <maxnoofCellsinCHO> | | | YES | reject |
| Cells To Be | | | | | | |
| Cancelled | | | | | | |
| List | | | | | | |
| >Target | M | | Target | | — | — |
| Cell ID | | | Cell | | | |
| | | | Global ID | | | |
| | | | 9.2.3.25 | | | |
| Candidate | | | | | | |
| Relay | | | | | | |
| UE(s) ID | | | | | | |
| Cause | M | | 9.2.3.2 | | YES | ignore |

TABLE 4

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| Source | M | | NG-RAN | Allocated at | YES | reject |
| NG-RAN | | | node UE | the source | | |
| node UE | | | XnAP ID | NG-RAN | | |
| XnAP ID | | | 9.2.3.16 | node. | | |
| Target | M | | NG-RAN | Allocated at | YES | reject |
| NG-RAN | | | node UE | the target | | |
| node UE | | | XnAP ID | NG-RAN | | |
| XnAP ID | | | 9.2.3.16 | node. | | |
| Candidate | | 0 . . . <maxnoofCellsinCHO> | | | YES | reject |
| Cells To Be | | | | | | |
| Cancelled | | | | | | |
| List | | | | | | |
| >Target | M | | Target Cell | | — | — |
| Cell ID | | | Global ID | | | |
| | | | 9.2.3.25 | | | |
| Candidate | | | | | | |
| Relay UE | | | | | | |
| List To Be | | | | | | |
| Cancelled | | | | | | |
| Cause | M | | 9.2.3.2 | | YES | ignore |

In some other embodiments of FIG. 4, the ID information of the set of candidate relay UEs may be added to the Xn message e.g. the HANDOVER CANCEL message as child-level information of the ID information of the target relay UE, for example, “Candidate Relay UE(s) ID” is child-level information of “Target Cell ID” as shown in Table 5 or “Candidate Relay UE List To Be Cancelled” is child-level information of “Target Cell ID” as shown in Table 6 as below.

TABLE 5

| IE/Group | | | IE type and | Semantics | | Assigned |
|---|---|---|---|---|---|---|
| Name | Presence | Range | reference | description | Criticality | Criticality |
| Message Type | M | | 9.2.3.1 | | YES | ignore |
| Source | M | | NG-RAN | Allocated at | YES | reject |
| NG-RAN node | | | node UE | the source | | |
| UE XnAP ID | | | XnAP ID | NG-RAN | | |
| | | | 9.2.3.16 | node. | | |
| Target | M | | NG-RAN | Allocated at | YES | reject |
| NG-RAN node | | | node UE | the target | | |
| UE XnAP ID | | | XnAP ID | NG-RAN | | |
| | | | 9.2.3.16 | node. | | |
| Candidate | | 0 . . . <maxnoofCellsinCHO> | | | YES | reject |
| Cells To Be | | | | | | |
| Cancelled List | | | | | | |
| >Target Cell | M | | Target | | — | — |
| ID | | | Cell | | | |
| | | | Global ID | | | |
| | | | 9.2.3.25 | | | |
| >>Candidate | | | | | | |
| Relay UE(s) | | | | | | |
| ID | | | | | | |
| Cause | M | | 9.2.3.2 | | YES | ignore |

TABLE 6

| IE/Group | | | IE type and | Semantics | | Assigned |
|---|---|---|---|---|---|---|
| Name | Presence | Range | reference | description | Criticality | Criticality |
| Message Type | M | | 9.2.3.1 | | YES | ignore |
| Source | M | | NG-RAN | Allocated at | YES | reject |
| NG-RAN node | | | node UE | the source | | |
| UE XnAP ID | | | XnAP ID | NG-RAN | | |
| | | | 9.2.3.16 | node. | | |
| Target | M | | NG-RAN | Allocated at | YES | reject |
| NG-RAN node | | | node UE | the target | | |
| UE XnAP ID | | | XnAP ID | NG-RAN | | |
| | | | 9.2.3.16 | node. | | |
| Candidate | | 0 . . . <maxnoofCellsinCHO> | | | YES | reject |
| Cells To Be | | | | | | |
| Cancelled List | | | | | | |
| >Target Cell | M | | Target | | — | — |
| ID | | | Cell | | | |
| | | | Global ID | | | |
| | | | 9.2.3.25 | | | |
| >>Candidate | | | | | | |
| Relay UE List | | | | | | |
| To Be | | | | | | |
| Cancelled | | | | | | |
| Cause | M | | 9.2.3.2 | | YES | ignore |

Referring back to FIG. 4, in some embodiments, message #3 may include the ID information of a set of candidate cells associated with the other candidate network nodes. The other candidate network nodes may consider that the source network node is cancelling only a handover associated with the set of candidate cells and one or more candidate relay UEs served by the set of candidate cells.

In some embodiments, the source network node may receive at least one of the following from the UE:
(1) a message associated with a relay link change failure during path switching from an indirect path (e.g., indirect path #1 in the embodiments of FIG. 3) between the UE and the source network node associated with a source relay UE to another indirect path (e.g., indirect path #2 in the embodiments of FIG. 3) between the UE and the source network node associated with a target relay UE; or
(2) information related to a fallback operation performed by the UE to communicate with the source network node over the indirect path (e.g., indirect path #1 in the embodiments of FIG. 3) between the UE and the source network node associated with the source relay UE.

FIG. 5 illustrates a flow chart of a method of receiving a handover request in accordance with some embodiments of the present application. The method may be performed by a candidate network node (e.g., ng-eNB 203 or candidate BS(s) 805 as illustrated and shown in FIG. 2 or FIG. 8). Although described with respect to a candidate network node (e.g., a candidate BS), it should be understood that other devices may be configured to perform a method similar to that of FIG. 5. A specific example of the embodiments of FIG. 5 is described in the embodiments of FIG. 8 as follows.

In the exemplary method 500 as shown in FIG. 5, in operation 501, a candidate network node (e.g., candidate BS(s) 805 illustrated and shown in FIG. 8) may receive a handover request for a path switching operation from a source network node (e.g., source BS 803 illustrated and shown in FIG. 8). The handover request may include ID information of a requested target relay UE of a target network node. The source network node may communicate with a UE (e.g., UE 801 illustrated and shown in FIG. 8) over at least one of a direct path or an indirect path between the UE and the source network node associated with a source relay UE (e.g., source relay UE 802 illustrated and shown in FIG. 8).

In operation 502, the candidate network node may transmit a response message to the source network node. The response message includes ID information of a candidate relay UE associated with the candidate network node.

In some embodiments, the candidate network node may transmit a message (e.g., “message #1” in the embodiments of FIG. 4) to the source network node. This message may indicate the source network node to cancel the path switching operation to the candidate relay UE. In some embodiments, the message includes at least one of the following: ID information of the candidate relay UE; or a cause for cancelling the path switching operation to the candidate relay UE. In an embodiment, the message may be a conditional handover cancel message or a conditional path switching cancel message.

In some embodiments, the candidate network node may transmit a message (e.g., “message #2” in the embodiments of FIG. 4) to the source network node. This message may indicate that the UE has successfully accessed to the candidate relay UE, and the candidate relay UE acts as a target relay UE (e.g., target relay UE 804 illustrated and shown in FIG. 8). In an embodiment, this message may be a handover success message. In some embodiments, this message includes at least one of the following: the ID information of the requested target relay UE; ID information of the target relay UE; or ID information of a target cell of the target relay UE.

In some embodiments, at least one of the ID information of the target relay UE or the ID information of the target cell is added to message #2 as: independent from the ID information of the requested target relay UE; or child-level information of the ID information of the requested target relay UE.

In some embodiments, message #2 may include the ID information of the requested target relay UE. The source network node may consider that the UE has successfully accessed the candidate relay UE corresponding to the ID information of the requested target relay UE.

In some embodiments, the candidate network node may receive a message (e.g., “message #3” in the embodiments of FIG. 4) from the source network node. This message may indicate at least one of the following: to cancel an ongoing path switching preparation operation or an already prepared path switching operation to a set of candidate relay UEs including the candidate relay UE; or the UE has successfully accessed to a target relay UE.

In some embodiments, message #3 may include at least one of the following: ID information of a set of candidate cells associated with the set of candidate network nodes including the candidate network node; or ID information of the set of candidate relay UEs including the candidate network node. In some embodiments, the ID information of the set of candidate relay UEs is added to message #3 as child-level information of the ID information of the target cell. In an embodiment, message #3may be a handover cancel message.

In some embodiments, message #3 may include the ID information of a set of candidate cells associated with a set of candidate network nodes including the candidate network node. The candidate network node may consider that the source network node is cancelling only a handover associated with the set of candidate cells and one or more candidate relay UEs served by the set of candidate cells.

Details described in all other embodiments of the present application are applicable for the embodiments of any of FIGS. 3-5. Moreover, details described in the embodiments of any of FIGS. 3-5 are applicable for all the embodiments of FIGS. 1, 2, and 6-9. It should be appreciated by persons skilled in the art that the sequence of the operations in flow charts in the embodiments of any of FIGS. 3-5 may be changed and some of the operations in the flow charts in the embodiments of any of FIGS. 3-5 may be eliminated or modified, without departing from the spirit and scope of the disclosure.

The following texts describe specific embodiments of the methods as shown and illustrated in any of FIGS. 3-5.

FIG. 6 illustrates a flow chart of a relay link change operation in accordance with some embodiments of the present application. According to the flow chart 600 in the embodiments of FIG. 6, UE 601, source relay UE 602, BS 603, and target relay UE 604 perform the following operations.

In operation 611, UE 601 may access a serving BS, e.g., BS 603, via multiple paths. Multiple paths could include a direct path and/or an indirect path. The indirect path is associated with a relay UE (e.g., L2 U2N relay UE), for example, source relay UE 602 as shown in FIG. 6. The indirect path between UE 601 and source relay UE 602 may also be named as “a relay link” or “a source relay link”, “a source indirect link”, or the like. UE 601 may be named as “remote UE 601”, “L2 U2N remote UE 601” or the like. UE 601 may stay at an RRC connected state.

In some embodiments, UE 601 may report measurement result(s) to serving BS 603 based on configuration information received from BS 603. The measurement result(s) may include measurement result(s) associated with candidate cell(s) or candidate relay UE(s).

In operation 612, BS 603 may decide to switch from source relay UE 602 to a candidate relay UE, e.g., based on the measurement result(s) from UE 601.

In operation 613, BS 603 may send a relay link change indication to UE 601. The relay link change indication may also be named as “a relay change indication” or the like. In some embodiments, the relay link change indication may be included in an RRCReconfiguration message transmitted in operation 613. In an embodiment, identity (ID) information of the candidate relay UE(s) may also be included in the RRCReconfiguration message.

In operation 614, after UE 601 receives the relay link change indication, UE 601 may perform a relay link change procedure, which may also be named as “a relay change procedure” or the like. In some embodiments, UE 601 may start a timer for relay link change (e.g., timer T420 as specified in 3GPP standard document) upon receiving the relay link change indication. In some embodiments, UE 601 may not release the PC5 unicast link between UE 601 and source relay UE 602 during the relay link change procedure.

In operation 615, source relay UE 602 may transmit a notification message (e.g., NotificationMessageSidelink message) and/or a PC5 unicast link release message to UE 601 during the relay link change procedure performed by UE 601.

In some embodiments, source relay UE 602 may transmit the notification message or the PC5 unicast link release message due to at least one of the following: a Uu RLF between source relay UE 602 and BS 603, a cell reselection of source relay UE 602, a handover of source relay UE 602, an RRC connection rejection message received by source relay UE 602, an expiry of a timer for RRC setup request (e.g., timer T300) at source relay UE 602, a Uu RRC connection establishment failure of source relay UE 602, and/or a Uu RRC connection resume failure of source relay UE 602.

In operation 616, after UE 601 receives the notification message and/or the PC5 unicast link release message from source relay UE 602 during the relay link change procedure, there may be following different embodiments in different cases.

In some embodiments, UE 601 may ignore the notification message and/or PC5 unicast link release message from source relay UE 602, if UE 601 does not release the PC5 unicast link between UE 601 and source relay UE 602 yet during an indirect-to-indirect path switching procedure (e.g., when timer T420 is running).

In some further embodiments, UE 601 may stop receiving data (e.g., control plane (CP) data and/or user plane (UP) data) upon receiving the notification message and/or the PC5 unicast link release message from source relay UE 602 when the timer for path switching (e.g., timer T304 as specified in 3GPP standard document) is running.

In some other embodiments, UE 601 may stop receiving data (e.g., CP and/or UP data) and release the PC5 RRC connection upon receiving the notification message or the PC5 unicast link release message from source relay UE 602 when the timer for path switching (e.g., timer T304) is running.

In operation 617 (optional), UE 601 may stop the timer for relay link change (e.g., timer T420) upon successfully completing a random access (RA) procedure to target relay UE 604 or upon sending an RRCReconfigurationComplete message to BS 603.

In some embodiments, BS 603 may send an RRCReconfiguration message to source relay UE 602 to reconfigure the connection between relay UE 602 and BS 603.

In some embodiments, either source relay UE 602 or UE 601 may release a PC5 RRC connection between source relay UE 602 and UE 601, and may indicate upper layer(s) to release the PC5 unicast link between source relay UE 602 and UE 601.

In operation 618, a data path is switched from the indirect path between UE 601 and source relay UE 602 to another indirect path between UE 601 and target relay UE 604.

FIG. 7 illustrates a flow chart of a relay link change operation in accordance with some embodiments of the present application. According to the flow chart 700 in the embodiments of FIG. 7, UE 701, source relay UE 702, BS 703, and target relay UE 704 perform the following operations.

In operation 711, UE 701 accesses a serving BS, e.g., BS 703, via multiple paths. Multiple paths could include a direct path and/or an indirect path. The indirect path is associated with a relay UE (e.g., L2 U2N relay UE), for example, source relay UE 702 as shown in FIG. 7. The indirect path between UE 701 and source relay UE 702 may also be named as “a relay link”, “a source relay link”, “a source indirect link”, or the like. UE 701 may also be named as “remote UE 701”, “L2 U2N Remote UE 701” or the like. UE 701 may stay at an RRC connected state.

In some embodiments, UE 701 may report measurement result(s) to serving BS 703 based on configuration information from BS 703. The measurement result(s) may include measurement result(s) associated with candidate cell(s) or candidate relay UE(s).

In operation 712, BS 703 may decide to switch from source relay UE 702 to a candidate relay UE, e.g., based on the measurement result(s) from UE 701.

In operation 713, BS 703 may send a relay link change indication to UE 701, which may also be named as “a relay change indication” or the like. In some embodiments, the relay link change indication may be included in an RRCReconfiguration message transmitted in operation 713. ID information of the candidate relay UE(s) may be included in the RRCReconfiguration message.

In operation 714, after UE 701 receives the relay link change indication, UE 701 may perform a relay link change procedure, which may also be named as “a relay change procedure” or the like. In some embodiments, UE 701 may start a timer for relay link change (e.g., timer T420) upon receiving the relay link change indication. In some embodiments, UE 701 may keep the source relay link between UE 701 and source relay UE 702 during the relay link change procedure. UE 701 may continue to receive and transmit data via the source relay link before a target relay link between UE 701 and a target relay UE (e.g., target relay UE 704) is available.

After operation 714, a relay link change failure may happen. For instance, in some embodiments, in operation 715A (optional), the timer for relay link change (e.g., timer T420) may expire. In some other embodiments, in operation 715B (optional), remote UE 701 may receive a notification message (e.g., a NotificationMessageSidelink message) or a PC5 unicast link release message from target relay UE 704.

In operation 716, once the relay link change failure happens, UE 701 may transmit a message associated with a relay link change failure to BS 703. For example, the message may include an indication of a relay link change failure. A relay link change failure may also be named as “a relay change failure” or the like.

In some embodiments, UE 701 may transmit the message including the failure related information to source serving BS 703 in operation 716. The failure related information reported in operation 716 may include at least one of the following:
(1) The timer for relay link change (e.g., timer T420) expires.
(2) UE 701 receives a notification message (e.g., NotificationMessageSidelink message) or the PC5 unicast link release message from target relay UE 704, e.g., in operation 715B. In an embodiment, the notification message may indicate at least one of the following: a Uu RLF between source relay UE 702 and BS 703; a cell reselection of source relay UE 702; a handover of source relay UE 702; an RRC connection failure of source relay UE 702; an RRC connection rejection message received by source relay UE 702; an expiry of a timer for RRC setup request at source relay UE 702; or an RRC resume failure of source relay UE 702.
(3) The measurement result(s) associated with the candidate cell(s) and the candidate relay UE(s).

After operation 716, UE 701 may switch back to the source indirect path between UE 701 and source relay UE 702. In some embodiments, in operation 717 (optional), UE 701 may continue to keep the source indirect path between UE 701 and source relay UE 702 until UE 701 receives an indication to release source relay link, and may perform a fallback operation to communicate with BS 703 over the source indirect path, if UE 701 fails to access target relay UE 704. In an embodiment, upon an expiry of the timer for relay link change (e.g., timer T420), UE 701 may determines that UE 701 fails to access the target relay UE 704 and then perform the fallback operation. In another embodiment, after receiving the notification message or PC5 unicast link release message from target relay UE 704 in operation 715B (optional), UE 701 may perform the fallback operation. For instance, by performing the fallback operation, UE 701 may resume the source relay UE link between UE 701 and source relay UE 702.

In the embodiments of the subject application, when a remote UE (e.g., UE 701), which is communicating with a BS (e.g., BS 703) via a target relay UE (e.g., target relay UE 704), performs a fallback operation, the remote UE may release a PC5 link between the remote UE and the target relay UE and communicate with the BS via an indirect PC5 link between the remote UE and the source relay UE (e.g., target relay UE 702). Namely, by performing a fallback operation, the remote UE may switch back from the target relay link to the source relay link.

In operation 718 (optional), remote UE 701 may report information related to the fallback operation to BS 703.

FIG. 8 illustrates a flow chart of a path switching operation to a relay UE in accordance with some embodiments of the present application. According to the flow chart 800 in the embodiments of FIG. 8, UE 701, source relay UE 802, source BS 803, target relay UE 804, and candidate BS(s) 805 perform the following operations.

In operation 811, UE 801 accesses a serving gNB, e.g., BS 803, via one direct or one indirect path or multiple paths. The indirect path is associated with a relay UE (e.g., L2 U2N relay UE), for example, source relay UE 802 as shown in FIG. 8. The indirect path between UE 801 and source relay UE 802 may also be named as “a relay link”, “a source relay link”, “a source indirect link” or the like. UE 801 may also be named as “remote UE 801”, “L2 U2N Remote UE 801” or the like. UE 801 may stay at an RRC connected state.

In some embodiments, UE 801 may report measurement result(s) to serving BS 803 based on configuration information from BS 803. The measurement result(s) may include measurement result(s) associated with the candidate cell(s) or the candidate relay UE(s).

In some embodiments, UE 801 may evaluate whether some event(s), e.g., EventZ1 and/or EventZ2 as described above, are met. When such event(s) is met, UE 801 may report the measurement result(s).

In operation 812, BS 803 may decide to switch to a candidate relay UE based on the measurement report from UE 801, e.g., based on the measurement result(s) from UE 801.

In operation 813, BS 803 may send a handover request message to one or more candidate BSs, e.g., candidate BS(s) 804 as shown in FIG. 8. For example, candidate BS(s) 804 includes candidate gNB #1, candidate gNB #2, and candidate gNB #3. BS 803 may also be named as “source BS 803”, “source NG-RAN node 803”, or the like. Candidate BS(s) 804 may also be named as “candidate NG-RAN node 804” or the like.

In some embodiments, a PC5 resource should be added in the handover request message. Then, the information can be used by a target BS to avoid resource overlapping. For instance, a resource pool for transmission and/or reception for each candidate BS 804 is not overlapped with each other.

In some embodiments, ID information of one or more candidate relay UE is included in the handover request message. The corresponding measurement result(s) for these candidate relay UEs may be included in the handover request message. The preferred RRC state for candidate relay UE may be also included since the idle or inactive state can be selected as a target relay UE. The resource(s) configured for source PC5 link may be included in the handover request message.

In operation 814, after receiving the handover request message from source BS 803, candidate BS(s) 804 may determine its associated candidate relay UE. For instance:
(1) candidate gNB #1 may determine an ID of one candidate relay UE, e.g., candidate relay UE #1.
(2) candidate gNB #2 may determine an ID of one candidate relay UE, e.g., candidate relay UE #2.
(3) candidate gNB #3 may determine an ID of one candidate relay UE, e.g., candidate relay UE #3.

In operation 815, candidate BS(s) 804, e.g., candidate gNB #1, candidate gNB #2, and candidate gNB #3, may transmit a handover request acknowledge message to source BS 803. In some embodiments, the handover request acknowledge message may include at least the following information:
(1) ID information of a separate target relay UE. This target relay UE may be out of the container including an RRC reconfiguration message.
(2) The RRC state of the candidate relay UE.

In operation 816, source BS 803 may transmit an RRC reconfiguration message associated with the candidate relay UE(s), e.g., candidate relay UE #1, candidate relay UE #2, and candidate relay UE #3, to remote UE 801.

In some embodiments, the RRC reconfiguration message may include the individual set of conditions for each of the candidate relay UE(s) for conditional path switching. Different candidate relay UE may be configured with different sets of conditions for conditional path switching.

In operation 817, UE 801 may start to evaluate the conditions for candidate relay UE #1, candidate relay UE #2, and candidate relay UE #3. In some embodiments, UE 801 may evaluate whether some event(s), e.g., EventZ1 and/or EventZ2 as described above, are met. When such event(s) for any one candidate relay UE is met, UE 801 may perform a path switching operation to this candidate relay UE. For example, if remote UE 801 determines that EventZ1 and/or EventZ2 for candidate relay UE #1 are met, remote UE 801 may perform a path switching operation to candidate relay UE #1.

In operation 818 (optional), a candidate network node (e.g., candidate gNB #2) may transmit a message via Xn interface to cancel the conditional path switching to the candidate relay UE (e.g., candidate relay UE #2) which is associated with this candidate network node. In some embodiments, the message via Xn interface could be a conditional handover cancel message or a conditional path switching cancel message. For example, the message includes at least one of the following:
(1) an ID of the candidate relay UE (e.g., candidate relay UE #2); or
(2) a new cause for cancelling the path switching operation to the candidate relay UE, e.g., the candidate relay UE is unreachable.

In operation 819 (optional), once source BS 803 receives the message to cancel the conditional path switching, source BS 803 may transmit the corresponding configuration to UE 801 for removing the conditional path switching to the candidate relay UE (e.g., candidate relay UE #2).

In some embodiments, source BS 803 may consider that the target network node is about to remove any reference to, and release any resources previously reserved for candidate relay UEs.

In some embodiments, source BS 803 may transmit an Xn message to cancel the prepared target relay UE. For example, source BS 803 may transmit an Xn message to other candidate network node (e.g., candidate gNB #1 and/or candidate gNB #3) to cancel the ongoing path switching. For instance, the message can be a handover cancel message. ID information of the candidate relay UE, e.g., ID of candidate relay UE #3, may be included in the Xn message.

In an embodiment, only cell ID other than candidate relay UE ID is added in the handover cancel message. The candidate network node shall consider that the source NG-RAN node is cancelling only the handover associated to the candidate cell and candidate relay UE served by this candidate cell.

In a further embodiment, ID information of the candidate relay UE is added in the handover cancel message. If the Candidate relay UE list to be cancelled IE is included in the handover cancel message, the target network node shall consider that the source network node is cancelling the handover associated to the candidate relay UE. In another embodiment, ID information of the candidate relay UE is added as child-level of the ID information of the target cell, e.g., “Candidate Relay UE(s) ID” is added as child-level of “Target Cell ID” in Table 5, or “Candidate Relay UE List To Be Cancelled” is child-level information of “Target Cell ID” in Table 6 as shown above.

In operation 820, UE 801 may apply the configuration for path switching to a candidate relay UE (e.g., candidate relay UE #1) once the path switching condition is met. The candidate relay UE acts as target relay UE #1.

In some embodiments, UE 801 may start a timer for conditional path switching to target relay UE #1 (e.g., timer T420) when one of:
(1) upon path switching to target relay UE execution.
(2) when applying a stored RRCReconfiguration message including “reconfigurationWithSync for path switching to target relay UE”. For example, during applying the stored RRCReconfiguration message, UE 801 may apply parameters included in the stored RRCReconfiguration message.
(3) when applying a stored RRCReconfiguration message including “an indication of path switching to target relay UE”.

In operation 821, after remote UE 801 successfully accesses target relay UE 804 (e.g., candidate relay UE #1, which acts as target relay UE #1), the related target network node (e.g., target gNB #1) will transmit a message indicating that UE 801 has successfully completed the path switching to source BS 803.

In some embodiments, ID information of the target relay UE (e.g., target relay UE #1) is included in the message indicating the successful path switching. The message could be a handover success message.

In operation 822, source BS 803 may release context of UE 801 after receiving the message, e.g., the handover success message. In some embodiments, source BS 803 may inform this successful path switching to other candidate network node(s), e.g., candidate relay UE #2, and/or candidate relay UE #3.

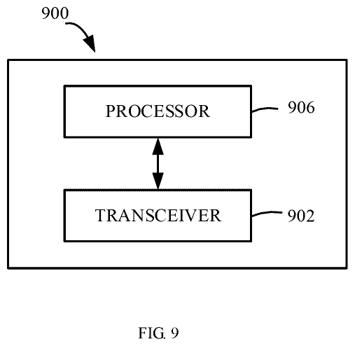

FIG. 9 illustrates a block diagram of an exemplary apparatus 900 in accordance with some embodiments of the present application. As shown in FIG. 9, the apparatus 900 may include at least one processor 906 and at least one transceiver 902 coupled to the processor 906. The apparatus 900 may be a UE, a source network node (e.g., a source BS), or a candidate network node (e.g., a candidate BS).

Although in this figure, elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The transceiver 902 and the processor 906 may interact with each other so as to perform the operations with respect to the UEs described in FIGS. 1-8. In some embodiments of the present application, the apparatus 900 may be a source network node (e.g., a source BS). The transceiver 902 and the processor 906 may interact with each other so as to perform the operations with respect to the source network nodes described in FIGS. 1-8. In some embodiments of the present application, the apparatus 900 may be a candidate network node (e.g., a candidate BS). The transceiver 902 and the processor 906 may interact with each other so as to perform the operations with respect to the candidate network node described in FIGS. 1-8.

In some embodiments of the present application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to the UEs as described above. For example, the computer-executable instructions, when executed, cause the processor 906 interacting with transceiver 902 to perform the operations with respect to the UEs described in FIGS. 1-8.

In some embodiments of the present disclosure, the non-transitory computer-readable medium may have stored thereon computer-executable instructions to cause the processor 906 to implement the method with respect to the source network nodes (e.g., the source BSs) as described above. For example, the computer-executable instructions, when executed, cause the processor 906 interacting with transceiver 902 to perform the operations with respect to the source network nodes described in FIGS. 1-8.

In some embodiments of the present disclosure, the non-transitory computer-readable medium may have stored thereon computer-executable instructions to cause the processor 906 to implement the method with respect to the candidate network nodes (e.g., candidate BSs) as described above. For example, the computer-executable instructions, when executed, cause the processor 906 interacting with transceiver 902 to perform the operations with respect to the candidate network nodes described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a radio resource control (RRC) reconfiguration message from a network node, wherein the RRC reconfiguration message includes one of:
a relay link change indication if the UE accesses the network node over both a direct path between the UE and the network node and a first indirect path between the UE and the network node associated with a source relay UE; and
a path switching indication to a candidate relay UE if the UE accesses the network node over the direct path, the first indirect path, or both the direct path and the first indirect path; and
perform relay link change or path switching based on the RRC reconfiguration message.

2. A source network node for wireless communication, comprising:
at least one memory; and
at least one processor coupled with the at least one memory and configured to cause the source network node to:
transmit a handover request for a path switching operation to one or more candidate network nodes, wherein the handover request includes identity (ID) information of a requested target relay user equipment (UE) served by a target network node;
receive a response message from the one or more candidate network nodes, wherein the response message includes ID information of at least one candidate relay UE; and
transmit a radio resource control (RRC) reconfiguration message associated with the at least one candidate relay UE to a remote UE.

3. The source network node of claim 2, wherein the at least one processor is further configured to cause the source network node to communicate with the remote UE over at least one of a direct path or an indirect path between the remote UE and the source network node associated with a source relay UE.

4. The source network node of claim 2, wherein the RRC reconfiguration message includes at least one of the following:
the ID information of the at least one candidate relay UE; or
one or more sets of conditions associated with the at least one candidate relay UE.

5. The source network node of claim 2, wherein the at least one processor is further configured to cause the source network node to receive a first message from a first candidate network node within the one or more candidate network nodes, and wherein the first message indicates to the source network node to cancel the path switching operation to a first candidate relay UE associated with the first candidate network node.

6. The source network node of claim 5, wherein the first message includes at least one of the following:
ID information of the first candidate relay UE; or
a cause for cancelling the path switching operation to the first candidate relay UE.

7. The source network node of claim 2, wherein the at least one processor is further configured to cause the source network node to receive a second message from a second candidate network node within the one or more candidate network nodes, and wherein the second message indicates that the remote UE has successfully accessed to a target relay UE associated with the second candidate network node.

8. The source network node of claim 7, wherein the second message includes at least one of the following:
the ID information of the requested target relay UE;
ID information of the target relay UE; or
ID information of a target cell of the target relay UE.

9. The source network node of claim 8, wherein the ID information of the target relay UE is added to the second message as:
independent from the ID information of the requested target relay UE; or
child-level information of the ID information of the requested target relay UE.

10. The source network node of claim 7, wherein the second message includes the ID information of the requested target relay UE, and wherein the at least one processor is further configured to cause the source network node to determine that the remote UE has successfully accessed a candidate relay UE corresponding to the ID information of the requested target relay UE.

11. The source network node of claim 7, wherein the at least one processor is further configured to cause the source network node to transmit a third message to other candidate network nodes within the one or more candidate network nodes.

12. The source network node of claim 11, wherein the third message indicates at least one of the following:
to cancel an ongoing path switching preparation operation or an already prepared path switching operation to a set of candidate relay UEs associated with the other candidate network nodes; or
the remote UE has successfully accessed to the target relay UE.

13. The source network node of claim 11, wherein the third message includes at least one of the following:
ID information of a set of candidate cells associated with the other candidate network nodes; or
ID information of a set of candidate relay UEs associated with the other candidate network nodes.

14. (canceled)

15. (canceled)

16. The UE of claim 1, wherein, when the RRC reconfiguration message includes the relay link change indication, the at least one processor is further configured to cause the UE to: start a timer for relay link exchange upon receiving the RRC message, receive a first notification message or a first PC5 unicast link release message from the source relay UE during path switching from the first indirect path to a second indirect path between the UE and the network node associated with a target relay UE, or receive a second notification message or a second PC5 unicast link release from the target relay UE during path switching from the first indirect path to the second indirect path.

17. The UE of claim 16, wherein the first notification message or the second notification message indicates: a Uu radio link failure (RLF) on a Uu link, a relay UE cell reselection, a relay UE handover, a Uu RRC connection failure, a reception of an RRC connection rejection message, an expiry of a timer for an RRC setup request, or a Uu RRC resume failure.

18. The UE of claim 16, wherein, in response to receiving the first notification message or the first PC5 unicast link release message during path switching from the first indirect path to the second indirect path, the at least one processor is further configured to cause the UE to: ignore the first notification message or the first PC5 unicast link release message when the UE has not yet released a PC5 link between the UE and the source relay UE, stop receiving data from the source relay UE; or stop receiving the data from the source relay UE and release the PC5 link between the UE and the source relay UE.

19. The UE of claim 1, wherein the at least one processor is configured to cause the UE to transmit a first message associated with a relay link change failure to the network node in response to an expiry of the timer for relay link change, receiving the second notification message or the second PC5 unicast link release message, or combinations thereof.

20. The UE of claim 19, wherein the first message includes: the expiry of the timer for relay link change, the reception of the second notification message or the second PC5 unicast link release message from the target relay UE, or a set of measurement results associated with at least one candidate relay UE.

21. A method performed by a source network node, the method comprising:
transmitting a handover request for a path switching operation to one or more candidate network nodes, wherein the handover request includes identity (ID) information of a requested target relay user equipment (UE) served by a target network node;
receiving a response message from the one or more candidate network nodes, wherein the response message includes ID information of at least one candidate relay UE; and
transmitting a radio resource control (RRC) reconfiguration message associated with the at least one candidate relay UE to a remote UE.

22. A method performed by a user equipment (UE), the method comprising:
receiving a radio resource control (RRC) reconfiguration message from a network node, wherein the RRC reconfiguration message includes one of:
a relay link change indication if the UE accesses the network node over both a direct path between the UE and the network node and a first indirect path between the UE and the network node associated with a source relay UE; and
a path switching indication to a candidate relay UE if the UE accesses the network node over the direct path, the first indirect path, or both the direct path and the first indirect path; and
performing relay link change or path switching based on the RRC reconfiguration message.
